(19) United States
(12) Patent Application Publication
(10) Pub. No.: US 2020/0188800 A1
(43) Pub. Date: Jun. 18, 2020

(54) INTERACTIVE OBJECTS IN STREAMING MEDIA AND MARKETPLACE LEDGERS

(71) Applicant: SONY INTERACTIVE ENTERTAINMENT LLC, SAN MATEO, CA (US)

(72) Inventors: MISCHA STEPHENS, SAN MATEO, CA (US); DUSTIN CLINGMAN, SAN MATEO, CA (US); ADIL SHERWANI, SAN MATEO, CA (US)

(21) Appl. No.: 16/220,443

(22) Filed: Dec. 14, 2018

(51) Int. Cl. A63F 13/85; A63F 13/79; G07F 17/32; H04N 21/43

(52) U.S. Cl. CPC A63F 13/85; H04N 21/4307; G07F 17/3225; A63F 13/79

(57) ABSTRACT

A system and method for providing interactive media streaming is provided. A media file and an activity file associated with the media file may be stored in memory. The media file may include a plurality of time stamps and the activity file may include a corresponding plurality of time stamps. The media file may be streamed on a user device. An activity at a point in time may be displayed within the streaming media file. A user selection of an object in the streaming media at the point in time may be detected. One of the timestamps associated with the selected object may be identified. Object information may be retrieved from the associated activity file based on a match between the object timestamp and one of the corresponding plurality of timestamps of the activity file. The retrieved object information may be transmitted and displayed on the user device.

### BACKGROUND OF THE INVENTION

### 1. Field of the Invention

The present technology pertains to streaming media. More specifically, the present technology may provide interactive objects in streaming media and marketplace ledgers.

### 2. Description of the Related Art

Gaming media is an increasingly popular and growing information source for game players. Such gaming media (e.g., from a game publisher or game-related content created by peer players) may incentivize further gameplay, promote new features of a game or a new game, or provide gameplay help. Presently available gaming media may include media streamed to a user (e.g., video streams), which may feature unique activities or items. Typically, a user must search various sources to obtain more information pertaining to the unique activities or items.

Due to the popularity of gaming, viewing activities or objects out of context may frustrate a user. Lack of information pertaining to an activity or object may, for example, detract from the user experience because the user may not know how to access such activity or obtain such object. Further, such lack of information may dis-incentivize a user from gameplay.

There is, therefore, a need in the art for systems and methods for interactive objects in streaming media and marketplace ledgers.

### SUMMARY OF THE PRESENTLY CLAIMED INVENTION

Embodiments of the present invention include systems and methods for providing interactive objects in streaming media and marketplace ledgers. A media file and an activity file associated with the media file may be stored in memory. The media file may include a plurality of time stamps and the activity file may include a corresponding plurality of time stamps. Such activity file may further include data about the activity and objects within the activity. The media file may be retrieved by a server and streamed on a user device. Such user device may display an activity at a point in time within the streaming media file. A user selection of an object in the streaming media at the point in time may be detected. One of the timestamps associated with the selected object may be identified. Such object timestamp may correspond to the point in time. Object information may be retrieved from the associated activity file based on a match between the object timestamp and one of the corresponding plurality of timestamps of the activity file. The retrieved object information may be transmitted and displayed on the user device.

Various embodiments may include methods for providing interactive media streaming. Such methods may include retrieving a media file comprising a plurality of timestamps. Such methods may include streaming the media file on a user device. Such user device may display an activity at a point in time within the streaming media file. Such methods may include detecting a user selection of an object in the streaming media at the point in time. Such methods may include identifying one of the timestamps associated with the selected object. Such object timestamp may correspond to the point in time. Such methods may include retrieving an activity file associated with the media file. Such activity file may have a corresponding plurality of timestamps. Such activity file may include data about the activity and objects within the activity. Such methods may include retrieving object information from the activity file based on a match between the object timestamp and one of the corresponding plurality of timestamps of the activity file. Such methods may include transmitting the retrieved object information to the user device.

Additional embodiments may include systems for providing interactive media streaming. Such systems may include memory that stores at least one memory file and an associated activity file. Each of the media files may include a plurality of time stamps. Such associated activity file may include a corresponding plurality of time stamps. Such activity file may include data about the activity and objects within the activity. Such system may include a processor that executes instructions stored in memory. Execution of the instructions by the processor may retrieve a media file. Execution of the instructions by the processor may stream the media file on a user device. Such user device may display an activity at a point in time within the streaming media file. Execution of the instructions by the processor may detect a user selection of an object in the streaming media at the point in time. Execution of the instructions by the processor may identify one of the timestamps associated with the selected object. Such object timestamp may correspond to the point in time. Execution of the instructions by the processor may retrieve an activity file associated with the media file. Execution of the instructions by the processor may retrieve object information from the activity file based on a match between the object timestamp and one of the corresponding plurality of timestamps of the activity file. Execution of the instructions by the processor may transmit the retrieved object information to the user device.

Further embodiments include non-transitory computer-readable storage media having embodied thereon a program executable by a processor to provide interactive streaming media.

### BRIEF DESCRIPTION OF THE DRAWINGS

FIG. 1 illustrates an exemplary network environment in which a system for interactive objects in streaming media and marketplace ledgers may be implemented.

FIG. 2 illustrates a detailed exemplary network in which a system for binding data from a universal data system to user generated content may be implemented.

FIG. 3 is a flowchart illustrating an exemplary method for interactive objects in streaming media and marketplace ledgers.

FIG. 4 is an exemplary electronic entertainment system that may be used in providing interactive objects in streaming media and marketplace ledgers.

### DETAILED DESCRIPTION

The detailed description set forth below is intended as a description of various configurations of the subject technology and is not intended to represent the only configurations in which the technology can be practiced. The appended drawings are incorporated herein and constitute a part of the detailed description. The detailed description includes specific details for the purpose of providing a more thorough understanding of the technology. However, it will be clear and apparent that the technology is not limited to the specific details set forth herein and may be practiced without these details. In some instances, structures and components are shown in block diagram form in order to avoid obscuring the concepts of the subject technology.

Embodiments of the present invention include systems and methods for providing interactive objects in streaming media and marketplace ledgers. A media file and an associated activity file may be stored in memory. The media file may include a plurality of timestamps and the activity file may include a corresponding plurality of timestamps. Media associated with the media file may be streamed on a user device by a server. Such media may show an activity at a point in time within the streaming media file. A user selection of an object shown in the activity at the point in time may be received by the server. Such user selection may include an object time stamp from the plurality of timestamps of the media file corresponding to the point in time. The activity file associated with the media file may be retrieved by the server. Such activity file may include information about the activity and/or object. Information about the selected object may be retrieved based on a match between the object timestamp and one of the corresponding plurality of timestamps of the activity file. Such retrieved object information may be transmitted and/or displayed on the user device.

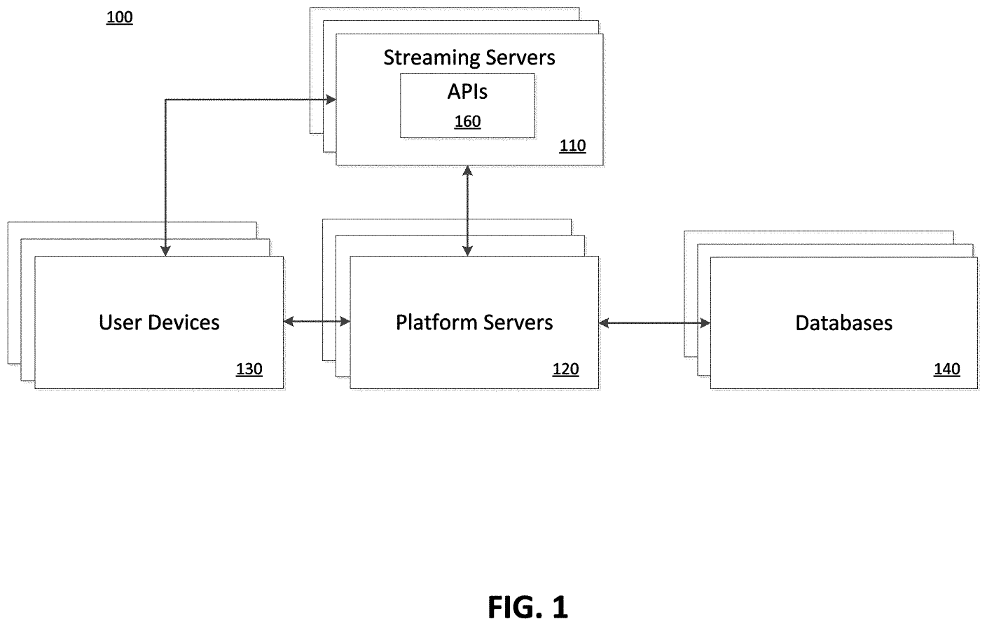

FIG. 1 illustrates an exemplary network environment 100 in which a system for providing interactive objects in streaming media and marketplace ledgers can occur. The network environment 100 may include one or more streaming servers 110 that provide streaming content (e.g., interactive video, podcasts, etc.), platform servers 120, one or more user devices 130, and one or more databases 140.

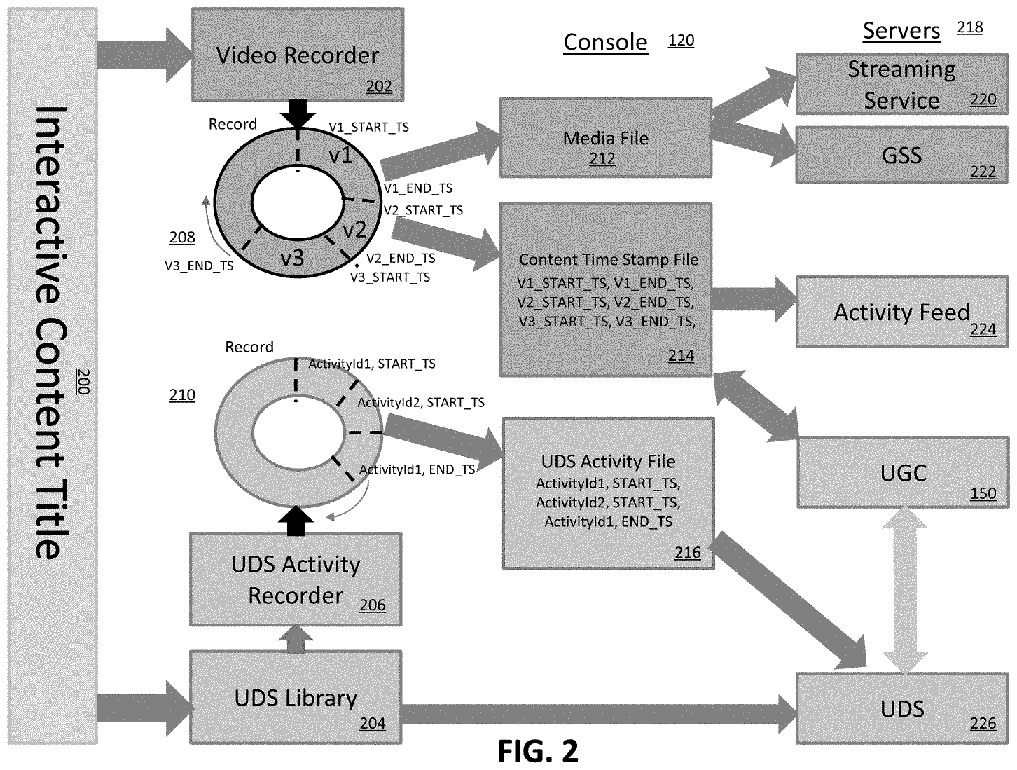

Media servers 110 may maintain and host interactive streaming media available to stream on a user device 130 over a communication network. Such streaming servers 110 may be implemented in the cloud (e.g., one or more cloud servers). Each streaming media may include one or more activities shown, and each activity may include one or more objects available for interaction with by a user. Data about a user interaction with an activity and/or object shown in the streaming media may be stored by the platform servers 120 and/or the user device 130, as will be discussed in detail with respect to FIG. 2.

The platform servers 120 may be responsible for communicating with the different streaming servers 110, databases 140, and user devices 130. Such platform servers 120 may be implemented on one or more cloud servers. The streaming servers 110 may communicate with multiple platform servers 120. The platform servers 120 may also carry out instructions, for example, retrieving a media file associated with a type of media (i.e., video, podcasts, User Generated Content, publisher content, etc.). Such media file may include a plurality of timestamps. The platform servers 120 may further carry out instructions, for example, for streaming the media on a user device. Such media may show an activity at a point in time. The platform servers 120 may further carry out instructions, for example, for receiving a user selection on an object shown in the streaming media at the point in time. Such user selection may include an object timestamp of the plurality of timestamps corresponding to the point in time. The platform servers 120 may further carry out instructions, for example, for retrieving an activity file associated with the media file. Such activity file may include a corresponding plurality of timestamps. The platform servers 120 may further carry out instructions, for example, for retrieving object information from the activity file based on a match between the object timestamp and one of the corresponding plurality of timestamps of the activity file. The platform servers 120 may further carry out instructions, for example, for transmitting the retrieved object information to the user device.

The streaming media and their corresponding activity information may be provided through an application programming interface (API) 160, which allows various types of streaming servers 110 to communicate with different platform servers 120 and different user devices 130. API 160 may be specific to the particular computer programming language, operating system, protocols, etc., of the streaming servers 110 providing the streaming media, the platform servers 120 providing the associated activity and/or object information, and user devices 130 receiving the same. In a network environment 100 that includes multiple different types of streaming servers 110 (or platform servers 120 or user devices 130), there may likewise be a corresponding number of APIs 160.

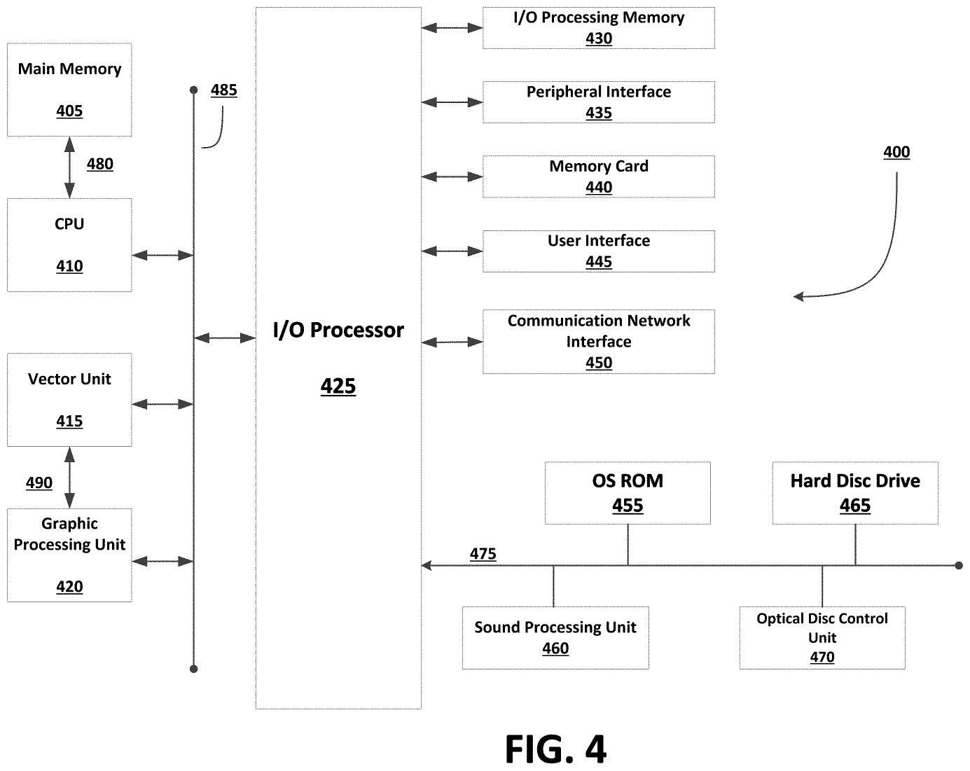

The user device 130 may include a plurality of different types of computing devices. For example, the user device 130 may include any number of different gaming consoles, mobile devices, laptops, and desktops. Such user device 130 may also be configured to access data from other storage media, such as, but not limited to memory cards or disk drives as may be appropriate in the case of downloaded services. Such devices 130 may include standard hardware computing components such as, but not limited to network and media interfaces, non-transitory computer-readable storage (memory), and processors for executing instructions that may be stored in memory. These user devices 130 may also run using a variety of different operating systems (e.g., iOS, Android), applications or computing languages (e.g., C++, JavaScript). An exemplary user device 130 is described in detail herein with respect to FIG. 4.

The databases 140 may be stored on the platform server 120, the streaming servers 110, on the same server, on different servers, on a single server, or across different servers. Such databases 140 may store history information for an object (e.g., ownership history, object history, and/or object modifications, etc.). Such databases 140 may also store streaming media from publishers of interactive content titles and/or third party publishers or UGG (e.g., screen shots, videos, commentary, mashups, etc.) created by peers. Such UGC may include metadata by which to search for such media. Such UGC may also include information about the interactive content title and/or peer. Such information may be derived from data gathered during peer interaction with an activity of an interactive content title. Such information may be “bound” to the UGC and stored with the UGC. Such binding enhances UGC as the UGC may deep link (e.g., directly launch) to an interactive content title, may provide for information about an activity and/or a peer of the UGC, and/or may allow a user to interact with the UGC.

In the exemplary network environment 200 of FIG. 2, an exemplary platform server 120 and exemplary end servers (e.g., streaming server 220, GSS 222, activity feed server 224, UGC server and database 150, and UDS server 226) are shown. In an exemplary example, a content recorder 202 receives and records content from an interactive content title 200 onto a content ring-buffer 208. Such ring-buffer 208 may store multiple content segments (e.g., v1, v2 and v3), start times for each segment (e.g., V1_START_TS, V2_START_TS, V3_START_TS), and end times for each segment (e.g., V1_END_TS, V2_END_TS, V3_END_TS). Such segments may be stored as a media file 212 (e.g., MP4, WebM, etc.) by the platform server 120. Such media file 212 may be uploaded to the streaming server 220 and/or the GSS 222 for storage. Such start times and end times for each segment may be stored as a content time stamp file 214 by the platform server 120. Such content time stamp file 214 may also include a streaming ID or GSS ID to link the content time stamp file 214 to the media file 212. Such content time stamp file 214 may be uploaded and stored to the activity feed server 224 and/or the UGC server and database 150.

Meanwhile, a UDS activity recorder 206 receives and records activity data from a UDS library 204 onto a UDS ring-buffer 210 (e.g., ActivityID1, START_TS; ActivityID2, START_TS; ActivityID3, START_TS). Such UDS library 204 receives data from the interactive content title 200 and may transmit data to the UDS activity recorder 206 when an activity occurs and/or transmit data to a UDS server 226. Such activity data can be stored in a UDS activity file 216 by the platform server 120. Such UDS activity File 216 may also include activity start times, activity end times, an activity ID, activity results, activity types (e.g., competitive match, quest, task, etc.), user or peer data related to the activity. For example, a UDS activity file 216 may store data regarding an item used during the activity.

Such UDS activity data may be associated with the content data. In one example, the UGC server 150 stores the content time stamp file 214. The UGC server 150 can associated the File 214 with the media file 212 by the streaming ID or GSS ID stored with the file 214. The UGC server 150 can also communicate with the UDS server 226 to query for a UDS activity file 216 that matches the content time stamp file 214. Such query can search by matching start time and end time of the content time stamp file 214 with the start time and end time of a corresponding UDS activity file 216. Such query can also search for a match between the activity ID stored with the UDS activity file 216 and the GSS ID or streaming ID of the content time stamp file 214. Such UDS activity file 216 may be associated with the matched content time stamp file 214 by the UGC server 150. In another example, a UDS activity file 216 and a content time stamp file 214 are associated by the platform server 120 during creation of each file 214, 216.

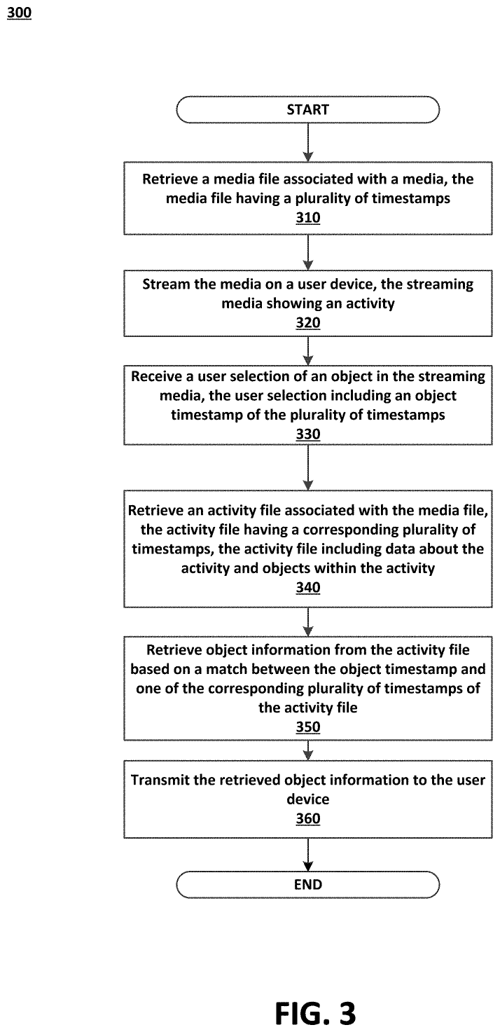

FIG. 3 is a flowchart illustrating an exemplary method 300 for providing interactive objects in streaming media and marketplace ledgers. The method 300 of FIG. 3 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The execution of the instructions may be implemented on the cloud servers (e.g., the steps identified in FIG. 3 are performed in the cloud). The steps identified in FIG. 3 (and the order thereof) are exemplary and may include various alternatives, equivalents, or derivations thereof including but not limited to the order of execution of the same.

In step 310, a media file (e.g., media file 212) associated with a type of media is retrieved by the platform server 120 from the streaming server 110, databases 140, and/or the user devices 130. Such media file may have a plurality of timestamps (e.g., content time stamp file 214). As previously described, the media may be UGC. An activity file (i.e., UDS activity file 216) associated with such UGC media may include data about the user of the UGC (e.g., user identity, user skills, interactive content titles owned and/or played by the user, etc.). Such activity file may also activity data (e.g., a result of a match or quest, activity type, number of users, duration, etc.). Alternatively, the media may be content published by a publisher of an interactive content title. Such activity file associated with producer media may include information about the interactive content title (e.g., type of activities offered in the title, multi- vs. single-user, special objects offered in the title, duration, etc. Such activity file may also include a link to the interactive content title such that the user can interactive with and/or purchase the interactive content title. If the user owns the interactive content title, the link may deep-link directly to the interactive content title such that the user can instantly begin interacting with the title after selecting an object of the content or selecting any portion of the content.

In step 320, the media may be streamed by the platform server 120 or the streaming server 110 on the user device 130. Such streaming media may be streamed by a media player or a website (e.g., YouTube, Media Player, Vimeo, etc.). Such streaming media may show an activity of an interactive content title at a point in time.

In step 330, a user selection of an object in the streaming media may be received by the platform server 120 at the point in time. For example, a user may view a streaming media wherein a character is shown using a sword. In the same example, the user may click or select the sword to receive more information about the sword. Such user selection may include an object timestamp of the plurality of timestamps associated with the media file and/or an object identification.

In step 340, an activity file associated with the media file may be retrieved by the platform server 120. Such activity file may have a corresponding plurality of timestamps corresponding to the plurality of timestamps of the media file. Such activity file may also include data about the activity (e.g., type, duration, number of users, results, etc.) and objects within the activity.

In step 350, object information (e.g., type, value, source, interactive content title, ability, etc.) may be retrieved by the platform server 120 from the activity file. Such retrieval may include identifying one of the timestamps associated with the selected object. Such object timestamp may correspond to the point in time. Such retrieval may be based on a match between the object timestamp and one of the corresponding plurality of timestamps of the activity file. Such retrieval may further be based on matching the object identification of the user selection to an object identification of the activity file.

The object information may include a unique identifier stored in a history ledger (e.g., ownership history, object history, and/or object modifications). Such unique identifier may protect against copies of the object. The history ledger may include unique storylines, videos, screenshots, and/or owners of the object. In one embodiment, the object information may include an ownership ledger having at least one unique owner identification identifying a current owner and/or previous owners. Such history and/or ownership ledger may be stored on the platform servers 120 or a separate server. Such ledger may also be a distributed ledger that is stored and updated across a plurality of servers and/or user devices. Such ledger may provide for objects that are tradable and/or sellable across interactive content titles.

In step 360, the retrieved object information may be transmitted to the user device 130 by the platform server 120. Such retrieved object information may be further displayed on the user device 130. Such object information may be displayed in an inset of the streaming media or on a separate display window. Further activity information may be displayed pertaining to the object. For example, a hint on where the object is located within the activity may be displayed to incentivize a user to continue or begin interaction with an interactive content title. In another example, a help video may be provided to aid the user in obtaining the object within the activity. Additionally, the history and/or ownership ledger may be displayed pertaining to the object. Such history and/or ownership ledger may incentive a user seek out the object based on, for example, a unique history or ties to a famous user.

Such systems and methods for provide interactive objects in streaming media and marketplace ledgers enhance a user's experience by providing for interactive streaming media. Such interactions may incentivize users to continue or begin gameplay with an interactive content title. Further, object information may incentivize a user to purchase the interactive content title associated with the object. Such object information may further incentivize a user to continue or begin interaction with an interactive content title to reach a certain time period in the title where the object is located. In other words, a user may be incentivized to continue playing a title until the object is reached. Further, unique ownership history may incentivize selling and/or trading of unique objects.

FIG. 4 is an exemplary user electronic entertainment system that may be used in launching interactive content and providing dynamic interfaces. The entertainment system 400 of FIG. 4 includes a main memory 405, a central processing unit (CPU) 410, vector unit 415, a graphics processing unit 420, an input/output (I/O) processor 425, an I/O processor memory 430, a peripheral interface 435, a memory card 440, a Universal Serial Bus (USB) interface 445, and a communication network interface 450. The entertainment system 400 further includes an operating system read-only memory (OS ROM) 455, a sound processing unit 460, an optical disc control unit 470, and a hard disc drive 465, which are connected via a bus 475 to the I/O processor 425.

Entertainment system 400 may be an electronic game console. Alternatively, the entertainment system 400 may be implemented as a general-purpose computer, a set-top box, a hand-held game device, a tablet computing device, a virtual reality device, an augmented reality device, or a mobile computing device or phone. Entertainment systems may contain more or less operating components depending on a particular form factor, purpose, or design.

The CPU 410, the vector unit 415, the graphics processing unit 420, and the I/O processor 425 of FIG. 4 communicate via a system bus 485. Further, the CPU 410 of FIG. 4 communicates with the main memory 405 via a dedicated bus 480, while the vector unit 415 and the graphics processing unit 420 may communicate through a dedicated bus 490. The CPU 410 of FIG. 4 executes programs stored in the OS ROM 455 and the main memory 405. The main memory 405 of FIG. 4 may contain pre-stored programs and programs transferred through the I/O Processor 425 from a CD-ROM, DVD-ROM, or other optical disc (not shown) using the optical disc control unit 470. I/O Processor 425 of FIG. 4 may also allow for the introduction of content transferred over a wireless or other communications network (e.g., 4G, LTE, 1G, and so forth). The I/O processor 425 of FIG. 4 primarily controls data exchanges between the various devices of the entertainment system 400 including the CPU 410, the vector unit 415, the graphics processing unit 420, and the peripheral interface 435.

The graphics processing unit 420 of FIG. 4 executes graphics instructions received from the CPU 410 and the vector unit 415 to produce images for display on a display device (not shown). For example, the vector unit 415 of FIG. 4 may transform objects from three-dimensional coordinates to two-dimensional coordinates, and send the two-dimensional coordinates to the graphics processing unit 420. Furthermore, the sound processing unit 460 executes instructions to produce sound signals that are outputted to an audio device such as speakers (not shown). Other devices may be connected to the entertainment system 400 via the USB interface 445, and the communication network interface 450 such as wireless transceivers, which may also be embedded in the system 400 or as a part of some other component such as a processor.

A user of the entertainment system 400 of FIG. 4 provides instructions via the peripheral interface 435 to the CPU 410, which allows for use of a variety of different available peripheral devices (e.g., controllers) known in the art. For example, the user may instruct the CPU 410 to store certain game information on the memory card 440 or other non-transitory computer-readable storage media or instruct a character in a game to perform some specified action.

The present invention may be implemented in an application that may be operable by a variety of end user devices. For example, an end user device may be a personal computer, a home entertainment system (e.g., Sony PlayStation2® or Sony PlayStation3® or Sony PlayStation4®), a portable gaming device (e.g., Sony PSP® or Sony Vita®), or a home entertainment system of a different albeit inferior manufacturer. The present methodologies described herein are fully intended to be operable on a variety of devices. The present invention may also be implemented with cross-title neutrality wherein an embodiment of the present system may be utilized across a variety of titles from various publishers.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method of providing interactive media streaming, the method comprising:
retrieving a media file comprising a plurality of timestamps;
streaming the media file on a user device, wherein the user device displays an activity at a point in time within the streaming media file;
detecting a user selection of an object in the streaming media at the point in time;
identifying one of the timestamps associated with the selected object, the object timestamp corresponding to the point in time;
retrieving an activity file associated with the media file, the activity file having a corresponding plurality of timestamps, the activity file including data about the activity and objects within the activity;
retrieving object information from the activity file based on a match between the object timestamp and one of the corresponding plurality of timestamps of the activity file; and
transmitting the retrieved object information to the user device.

2. The method of claim 1, wherein the media file includes user-generated content.

3. The method of claim 2, wherein the activity file includes data about an author of the user-generated content.

4. The method of claim 2, wherein the activity file includes data regarding at least one of a result, activity information, activity type, number of users, and duration.

5. The method of claim 1, wherein the media file is published by a publisher of an interactive content title.

6. The method of claim 5, wherein the media file is linked to the interactive content title, and wherein the media file prompts the user to interact with the linked interactive content title.

7. The method of claim 1, wherein the object information includes at least one of a type, value, source, and ability.

8. The method of claim 1, wherein the object information includes an ownership ledger.

9. The method of claim 8, wherein the ownership ledger includes at least one unique owner identification identifying a previous or current owner.

10. A system for providing interactive media streaming, the system comprising:
memory that stores:
at least one media file having a plurality of time stamps, and
an activity file associated with each media file, each activity file having a corresponding plurality of time stamps, each activity file including data about the activity and objects within the activity, and
a processor that executes instructions stored in memory, wherein execution of the instructions by the processor:
retrieves a media file,
streams the media file on a user device, wherein the user device displays an activity at a point in time within the streaming media file,
detects a user selection of an object in the streaming media at the point in time,
identifies one of the timestamps associated with the selected object, the object timestamp corresponding to the point in time,
retrieves an activity file associated with the media file,
retrieves object information from the activity file based on a match between the object timestamp and one of the corresponding plurality of timestamps of the activity file, and
transmit the retrieved object information to the user device.

11. The system of claim 10, wherein the media file includes user-generated content.

12. The system of claim 11, wherein the activity file includes data about an author of the user-generated content.

13. The system of claim 11, wherein the activity file includes data regarding at least one of a result, activity information, activity type, number of users, and duration.

14. The system of claim 10, wherein the media file is published by a publisher of an interactive content title.

15. The system of claim 14, wherein the media file is linked to the interactive content title, and wherein the media file prompts the user to interact with the linked interactive content title.

16. The system of claim 10, wherein the object information includes at least one of a type, value, source, and ability.

17. The system of claim 10, wherein the object information includes an ownership ledger.

18. The system of claim 17, wherein the ownership ledger includes at least one unique owner identification identifying a previous or current owner.

19. A non-transitory computer-readable medium having embodied thereon a program executable by a processor to provide interactive media streaming, the method comprising:
retrieving a media file comprising a plurality of timestamps;
streaming the media file on a user device, wherein the user device displays an activity at a point in time within the streaming media file;
detecting a user selection of an object in the streaming media at the point in time;
identifying one of the timestamps associated with the selected object, the object timestamp corresponding to the point in time;
retrieving an activity file associated with the media file, the activity file having a corresponding plurality of timestamps, the activity file including data about the activity and objects within the activity;
retrieving object information from the activity file based on a match between the object timestamp and one of the corresponding plurality of timestamps of the activity file; and
transmitting the retrieved object information to the user device.
